(19) United States
(12) Patent Application Publication
(10) Pub. No.: US 2020/0053417 A1
(43) Pub. Date: Feb. 13, 2020

(54) METHOD FOR COMMUNICATING WITH EXTERNAL ELECTRONIC DEVICE AND ELECTRONIC DEVICE SUPPORTING SAME

(71) Applicant: Samsung Electronics Co., Ltd., Gyeonggi-do (KR)

(72) Inventors: Yong Ha CHOI, Gyeonggi-do (KR); Tae Hyung KIM, Gyeonggi-do (KR); Sang Hun LEE, Gyeongsangbuk-do (KR); Ji Yoon PARK, Gyeonggi-do (KR); Dong Hyun YEOM, Gyeonggi-do (KR); Jung Eun LEE, Gyeonggi-do (KR)

(21) Appl. No.: 16/338,805

(22) PCT Filed: Sep. 29, 2017
(86) PCT No.: PCT/KR2017/010982

§ 371 Date: Apr. 2, 2019

(30) Foreign Application Priority Data
Oct. 10, 2016 (KR) 10-2016-0130519

(51) Int. Cl. H04N 21/434; H04N 21/4363; H04L 29/06; H04N 21/436

(52) U.S. Cl. CPC H04N 21/4343; H04N 21/43637; H04N 21/43615; H04L 69/16; H04N 21/4345; H04L 69/18

(57) ABSTRACT

An electronic device according to various embodiments of the disclosure may include a display, a memory, a communication module, and a processor, wherein the processor establish a channel with the external electronic device according to the Miracast scheme through the communication module, packetizes first data including video data or audio data into a first group, packetizes second data including control image data, which is output to receive a user input in the external electronic device, into a second group separately from the first group, transmits the first group of packets to the external electronic device according to a first communication protocol, and transmits the second group of packets to the external electronic device according to a second communication protocol.

### TECHNICAL FIELD

Various embodiments of the disclosure relate to a method of transmitting and receiving data to and from an external electronic device according to a Miracast communication scheme and an electronic device supporting the same.

### BACKGROUND ART

Electronic devices such as smartphones and tablet PCs may perform various functions such as wireless data communication, video playback, and Internet search. The electronic device may establish communication channels with nearby electronic devices and transmit and receive data. Of the various communication schemes, the Miracast communication scheme may be a method in which a source device that transmits content directly establishes a communication channel with a sink device that receives content and connects to the sink device. The content output from a display of the source device may be mirrored in real time and be output onto a display of the nearby sink device. Further, when a user input for operating a screen or an application is generated in the sink device, the signal related to the input is transmitted to the source device and may be executed in the source device.

### DISCLOSURE

### Technical Problem

The source device according to the related art may provide a control image corresponding to a hardware button to the sink device in the case of mirroring the screen by the Miracast technology. The sink device may output the control image to a portion of the display. When receiving a user input corresponding to the control image, the sink device may transmit information on the received user input to the source device to enable the user input to be processed. The source device operates in a manner of packetizing and processing the control image together with the video image, and when the user operates a control button, signal transmission may be delayed due to buffering or the like. In addition, the control image is simultaneously output from a display of the source device, which may cause inconvenience to the user.

### Technical Solution

An electronic device according to various embodiments of the disclosure may include a display, a memory, a communication module that transmits and receives data to and from an external electronic device, a processor electrically connected to the memory, the display, and the communication module, wherein the processor establish a channel with the external electronic device according to the Miracast scheme through the communication module, packetizes first data including video data or audio data into a first group, packetizes second data including control image data, which is output to receive a user input in the external electronic device, into a second group separately from the first group, transmits the first group of packets to the external electronic device according to a first communication protocol, and transmits the second group of packets to the external electronic device according to a second communication protocol.

### Advantageous Effects

The communication method and the electronic device supporting the communication method according to various embodiments of the disclosure may packetize data constituting a control image to be outputted in a sink device separately from video data or audio data.

The communication method and the electronic apparatus supporting the communication method according to various embodiments of the disclosure may transfer data associated with the control image to be output in the sink device to the sink device through a communication protocol different from that of the video data or the audio data.

The communication method and the electronic device supporting the communication method according to various embodiments of the disclosure may quickly transmit data constituting the control image to be output in the sink device to the sink device, thereby quickly coping with an input of a user.

### DESCRIPTION OF DRAWINGS

FIG. 1 illustrates connection between an electronic device and an external electronic device according to various embodiments;

FIG. 2 is a flowchart for describing a communication method using a Miracast scheme performed in a source device according to various embodiments;

FIG. 3 is a flowchart for describing a communication method using a Miracast scheme performed in a sink device according to various embodiments;

FIG. 4 is an exemplary diagram for describing screen mirroring between a source device and a sink device according to various embodiments;

FIG. 5 is a block diagram of a source device according to various embodiments;

FIG. 6 is a block diagram of a sink device according to various embodiments;

FIG. 7 is a diagram illustrating signal flow for transferring an input of a user in a sink device according to various embodiments;

FIG. 8 is a diagram of signal flow illustrating a negotiation process in Miracast communication according to various embodiments;

FIG. 9 is a first exemplary diagram for describing transmission of video images and control images according to types of a sink device according to various embodiments;

FIG. 10 is a second exemplary diagram for describing transmission of video images and control images according to types of a sink device according to various embodiments;

FIG. 11 is a third exemplary diagram for describing transmission of video images and control images according to types of a sink device according to various embodiments;

FIG. 12 illustrates an electronic device in network environment;

FIG. 13 illustrates a block diagram of an electronic device according to various embodiments; and

FIG. 14 illustrates a block diagram of a program module according to various embodiments.

### MODE FOR INVENTION

Hereinafter, various embodiments of the present disclosure will be described with reference to the accompanying drawings. Accordingly, those of ordinary skill in the art will recognize that modification, equivalent, and/or alternative on the various embodiments described herein can be variously made without departing from the scope and spirit of the present disclosure. With regard to description of drawings, similar components may be marked by similar reference numerals.

In the disclosure disclosed herein, the expressions “have”, “may have”, “include” and “comprise”, or “may include” and “may comprise” used herein indicate existence of corresponding features (for example, elements such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used herein may refer to various elements of various embodiments of the present disclosure, but do not limit the elements. For example, such terms are used only to distinguish an element from another element and do not limit the order and/or priority of the elements. For example, a first user device and a second user device may represent different user devices irrespective of sequence or importance. For example, without departing the scope of the present disclosure, a first element may be referred to as a second element, and similarly, a second element may be referred to as a first element.

It will be understood that when an element (for example, a first element) is referred to as being “(operatively or communicatively) coupled with/to” or “connected to” another element (for example, a second element), it can be directly coupled with/to or connected to the other element or an intervening element (for example, a third element) may be present. In contrast, when an element (for example, a first element) is referred to as being “directly coupled with/to” or “directly connected to” another element (for example, a second element), it should be understood that there are no intervening element (for example, a third element).

According to the situation, the expression “configured to” used herein may be used as, for example, the expression “suitable for”, “having the capacity to”, “designed to”, “adapted to”, “made to”, or “capable of”. The term “configured to (or set to)” must not mean only “specifically designed to” in hardware. Instead, the expression “a device configured to” may mean that the device is “capable of” operating together with another device or other components. CPU, for example, a “processor configured to (or set to) perform A, B, and C” may mean a dedicated processor (for example, an embedded processor) for performing a corresponding operation or a generic-purpose processor (for example, a central processing unit (CPU) or an application processor) which may perform corresponding operations by executing one or more software programs which are stored in a memory device.

Terms used in this specification are used to describe specified embodiments of the present disclosure and are not intended to limit the scope of the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

An electronic device according to various embodiments of the present disclosure may include at least one of smartphones, tablet personal computers (PCs), mobile phones, video telephones, electronic book readers, desktop PCs, laptop PCs, netbook computers, workstations, servers, personal digital assistants (PDAs), portable multimedia players (PMPs), MP3 players, mobile medical devices, cameras, and wearable devices. According to various embodiments of the present disclosure, the wearable devices may include accessories (for example, watches, rings, bracelets, ankle bracelets, glasses, contact lenses, or head-mounted devices (HIMDs)), cloth-integrated types (for example, electronic clothes), body-attached types (for example, skin pads or tattoos), or implantable types (for example, implantable circuits).

In some embodiments of the present disclosure, the electronic device may be one of home appliances. The home appliances may include, for example, at least one of a digital video disk (DVD) player, an audio, a refrigerator, an air conditioner, a cleaner, an oven, a microwave oven, a washing machine, an air cleaner, a set-top box, a home automation control panel, a security control panel, a TV box (for example, Samsung HomeSync™, Apple TV™, or Google TV™), a game console (for example, Xbox™ or PlayStation™), an electronic dictionary, an electronic key, a camcorder, or an electronic panel.

In another embodiment of the present disclosure, the electronic device may include at least one of various medical devices (for example, various portable medical measurement devices (a blood glucose meter, a heart rate measuring device, a blood pressure measuring device, and a body temperature measuring device), a magnetic resonance angiography (MRA), a magnetic resonance imaging (MRI) device, a computed tomography (CT) device, a photographing device, and an ultrasonic device), a navigation system, a global navigation satellite system (GNSS), an event data recorder (EDR), a flight data recorder (FDR), a vehicular infotainment device, electronic devices for vessels (for example, a navigation device for vessels and a gyro compass), avionics, a security device, a vehicular head unit, an industrial or home robot, an automatic teller's machine (ATM) of a financial company, a point of sales (POS) of a store, or an internet of things (for example, a bulb, various sensors, an electricity or gas meter, a spring cooler device, a fire alarm device, a thermostat, an electric pole, a toaster, a sporting apparatus, a hot water tank, a heater, and a boiler).

According to some embodiments of the present disclosure, the electronic device may include at least one of a furniture or a part of a building/structure, an electronic board, an electronic signature receiving device, a projector, or various measurement devices (for example, a water service, electricity, gas, or electric wave measuring device). In various embodiments of the present disclosure, the electronic device may be one or a combination of the aforementioned devices. The electronic device according to some embodiments of the present disclosure may be a flexible electronic device. Further, the electronic device according to an embodiment of the present disclosure is not limited to the aforementioned devices, but may include new electronic devices produced due to the development of technologies.

Hereinafter, electronic devices according to an embodiment of the present disclosure will be described with reference to the accompanying drawings. The term “user” used herein may refer to a person who uses an electronic device or may refer to a device (for example, an artificial electronic device) that uses an electronic device.

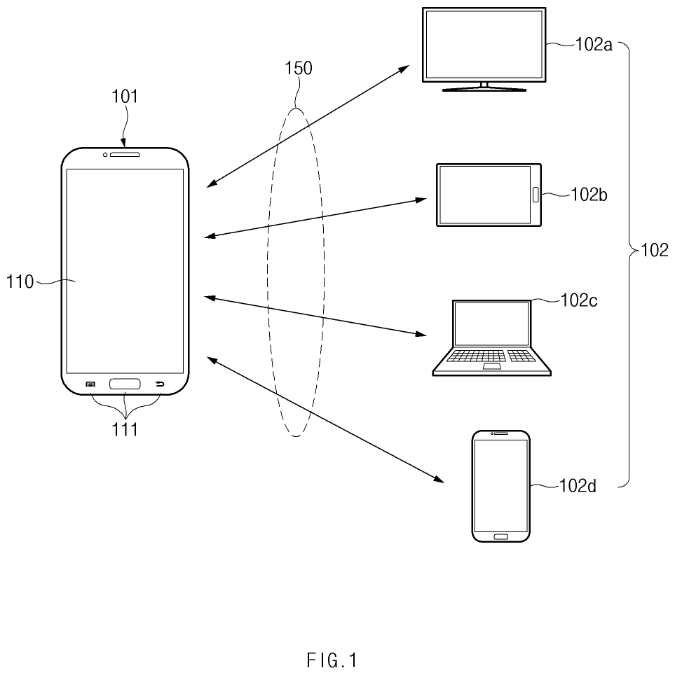

FIG. 1 illustrates connection between an electronic device and an external electronic device according to various embodiments.

Referring to FIG. 1, a first electronic device 101 may establish a wireless channel 150 with a second electronic device 102 and transmit and receive data to and from the second electronic device 102. In various embodiments, the first electronic device 101 may connect to the second electronic device 102 through communication according to the Miracast scheme. Content, such as images or text, output through a display 110 of the first electronic device 101 may be output to a display of the second electronic device 102 in real time (or within a predetermined period of time) (mirroring).

The Miracast is a wireless screencast technology/standard that allows video and audio content to be wirelessly transferred from the first electronic device 101 (e.g., a tablet, a smartphone, etc.) to the second electronic device 102 (e.g., a TV, a monitor 102a, a tablet PC 102b, a notebook PC 102c, a smartphone 102d, or the like) without requiring the use of a cable (e.g., an HDMI cable, a USB cable, etc.)

The Miracast technology may enable content to be shared by simplifying a process of directly establishing a high-speed wireless connection between two electronic devices. For example, the first electronic device 101 may transmit one of a unicast signal, a multicast signal, and a broadcast signal to an electronic device in a predetermined range and identify a response from nearby electronic devices. When a response is generated by the nearby electronic device, the first electronic device 101 may establish a communication channel 150 through an identification process or an authentication process.

Miracast connections may also be established through Wi-Fi Direct, and the Wi-Fi Direct may be a method for enabling Direct peer-to-peer Wi-Fi connection without the need for intermediate network components (e.g., servers or wireless access points). For example, the first electronic device 101 may output content (e.g., a YouTube video stream), output to the display 110, to a display of a nearby TV 102a having a Wi-Fi communication module using the Miracast technology in the same way.

Miracast protocols or standards may be advantageous for communication of large amounts of information (e.g., compressed video files), and may operate over Wi-Fi communication links and support uni-directional (or forward-only) communication. One of electronic devices communicating in the Miracast scheme may be a source device for providing content and the other may be a sink device for receiving content. Although a case in which the first electronic device 101 is a source device and the second electronic device 102 is a sink device will be mainly described below, embodiments are not limited thereto.

According to various embodiments, the first electronic device 101 may transmit, to the second electronic device 102, additional data (hereinafter referred to as sub-content) to be output along with video or audio data (hereinafter referred to as main content) output through the display 110 (or a speaker (not illustrated)). The sub-content may be a control image that allows the user to control an application executed in the first electronic device 101.

When the first electronic device 101 operates as a source device and the second electronic device 102 operates as a sink device, the sub-content for performing the same function as operation of a hardware button 111 (e.g., a physical button or a touch button) installed in the first electronic device 101 may be transmitted to the second electronic device 102. The second electronic device 102 may generate a control image based on the sub-content and output the generated control image together with the main content.

When the user generates a user input in the control image, the second electronic device 102 may transmit execution information according to the user input to the first electronic device 101. The first electronic device 101 may execute the same function (or operation) as execution of the hardware button 111 based on the received execution information. For example, when the user touches a control image corresponding to a home button in the second electronic device 102, the first electronic device 101 may execute the same function (e.g., move to a home screen) as in a case where the home button is pressed.

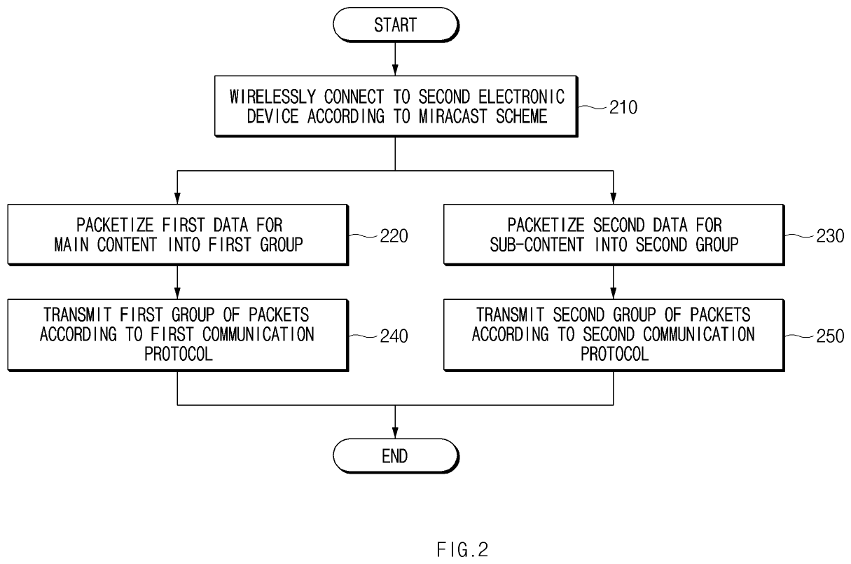

According to various embodiments, the sub-content may be packetized separately from the main content. In addition, the sub-content may be transmitted based on a communication method (or a communication protocol) different from that of the main content. Additional information regarding the transmission methods of the main content and the sub-content may be provided through FIGS. 2 to 6.

FIG. 2 is a flowchart for describing a communication method using a Miracast scheme performed in a source device according to various embodiments.

Referring to FIG. 2, in operation 210, the first electronic device 101 (source device) may wirelessly connect to the second electronic device 102 (sink device) according to the Miracast scheme. For example, the first electronic device 101 may transmit one of an anycast signal, a unicast signal, a multicast signal, and a broadcast signal to the second electronic device 102. When the first electronic device 101 receives a response signal from the second electronic device 102, the first electronic device 101 may perform an identification process or an authentication process (e.g., entering an authentication number, entering a password, etc.).

According to various embodiments, the first electronic device 101 may identify a format, a protocol, etc., supported by the second electronic device 102 in a process of recognizing the second electronic device 102. The first electronic device 101 may transmit the main content (e.g., video data, audio data) or sub-content (e.g., control image data) according to the format or protocol supported by the second electronic device 102.

In operation 220, the first electronic device 101 may packetize the first data for the main content, including video data or audio data, into a first group. For example, the first electronic device 101 may packetize the first data for the main content into a packetized elementary stream (hereinafter referred to as a PES) according to moving picture experts group 2 (MPEG 2).

In operation 230, the first electronic device 101 may packetize the second data associated with the sub-content, including the control image data output to receive a user input, into a second group. The first electronic device 101 may packetize the second data associated with the sub-content into a packet which is separate from the first data for the main content. For example, the first electronic device 101 may packetize the second data associated with sub-content into a packetized elementary stream (PES) according to MPEG-2.

In various embodiments, operation 220 and operation 230 may be exchanged with each other in sequence or performed concurrently.

In operation 240, the first electronic device 101 may transmit the first group of packets to the external electronic device 102 according to a first communication protocol. For example, the first electronic device 101 may transmit the first group of packets to the second electronic device 102 according to a Transmission Control Protocol (TCP), which ensures certainty of data transmission and reception.

In operation 250, the first electronic device 101 may transmit the second group of packets to the external electronic device 102 according to a second communication protocol. For example, the first electronic device 101 may transmit the second group of packets to the second electronic device 102 according to a User Datagram Protocol (UDP). In this case, the data of the second group of packets may be transmitted at a relatively high speed, although the certainty of transmission is not ensured.

In various embodiments, operation 240 and operation 250 may be exchanged with each other in sequence or performed concurrently.

A wireless communication method according to various embodiments may include establishing a channel with an external electronic device according to Miracast scheme, packetizing first data including video data or audio data into a first group, packetizing second data including control image data, which is output to receive a user input in the external electronic device, into a second group separately from the first group, transmitting the first group of packets to the external electronic device according to a first communication protocol, and transmitting the second group of packets to the external electronic device according to a second communication protocol.

According to various embodiments, the packetizing of the first data may include extracting media data stored in a graphic RAM included within a display driver integrated circuit which drives the display of the electronic device.

According to various embodiments, the packetizing of the first data may include extracting at least a part of a media file stored in a memory of the electronic device as video data or audio data.

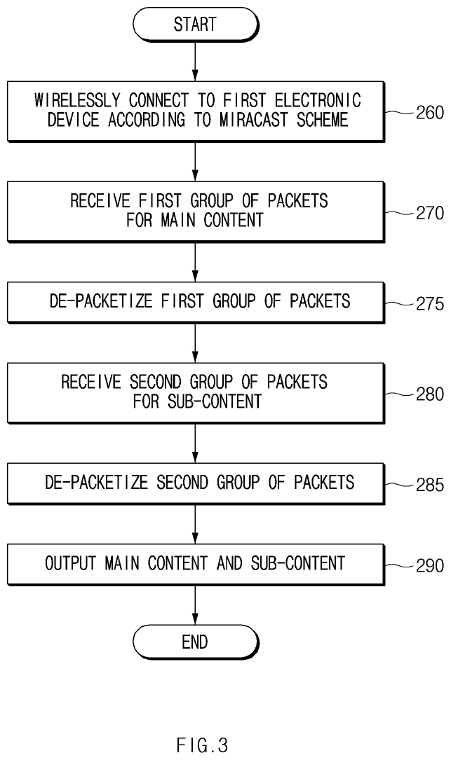

FIG. 3 is a flowchart for describing a communication method using a Miracast scheme performed in a sink device according to various embodiments.

Referring to FIG. 3, in operation 260, the second electronic device 102 (sink device) may wirelessly connect to the first electronic device 101 (source device) according to the Miracast scheme. For example, when the second electronic device 102 receives one of a unicast signal, a multicast signal, and a broadcast signal from the first electronic device 101, the second electronic device 102 may transmit a response signal to the first electronic device 101. The second electronic device 102 may wait in a state capable of receiving data from the first electronic device 101 through an identification process or an authentication process (e.g., entering an authentication number, entering a password, etc.).

In operation 270, the second electronic device 102 may receive a first group of packets for main content including video data or audio data. For example, the first group of packets for main content may be a Packetized Elementary Stream (PES) according to MPEG 2.

In operation 275, the second electronic device 102 may depacketize the first group of packets to form video data or audio data.

In operation 280, the second electronic device 102 may receive a second group of packets associated with sub-content including control image data output to receive a user input. For example, the second group of packets for sub-content may be a PES according to MPEG 2.

In operation 285, the second electronic device 102 may depacketize the second group of packets to form a control image.

In various embodiments, operations 280 and 285 may be exchanged with operations 270 and 275 in sequence or performed concurrently with operations 270 and 275.

In operation 290, the second electronic device 102 may output the main content and the sub-content. For example, the second electronic device 102 may output the main content by video data or audio data through a display or a speaker. The second electronic device 102 may output the control image to the display along with the video image.

According to various embodiments, when a user input is generated in the control image, the second electronic device 102 may transmit a relevant signal to the first electronic device 101.

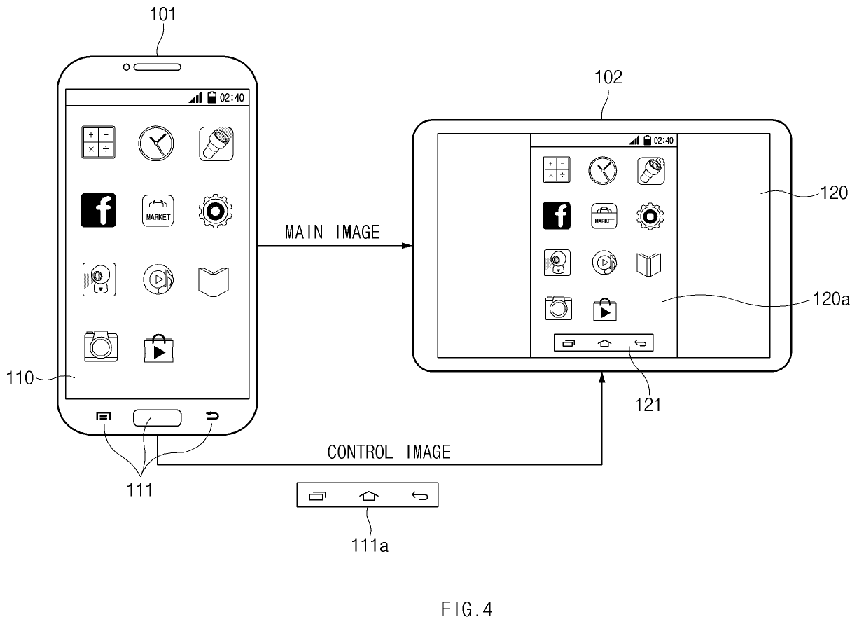

FIG. 4 is an exemplary diagram for describing screen mirroring between a source device and a sink device according to various embodiments. FIG. 4 is merely exemplary but is not limited thereto.

Referring to FIG. 4, the first electronic device 101 may operate as a source device that provides main content by the video data or the audio data and the second electronic device 102 may operate as a sink device that outputs the received main content. For example, the second electronic device 102 may output the same image as a home screen output to the display 110 of the first electronic device 101 to at least a portion 120a of a display 120. Although the main content is illustrated as being output to a portion of the display 120 in FIG. 4, embodiments are not limited thereto. For example, the main content may be output to an entire screen of the display 120 of the second electronic device 102.

According to various embodiments, the first electronic device 101 may transmit data 111a associated with the control image output to receive a user input. The data 111a associated with the control image may be an image output to the display 120 of the second electronic device 102 to provide the same function as operation of the hardware button 111 (e.g., a physical button or a touch button) installed in the first electronic device 101.

According to various embodiments, the first electronic device 101 may packetize the data 111a associated with the control image into a second group that is separate from a first group obtained by packetizing the video data (e.g., the image 120a) or the audio data. The first group of packets and the second group of packets may be transmitted to the second electronic device 102 independently of each other. In various embodiments, the first group of packets may be transmitted over a protocol in which reliability of data transmission is relatively ensured according to a TCP, and the second group of packets may be transmitted over a protocol in which a data transmission speed is relatively high according to a UDP.

According to various embodiments, the first group obtained by packetizing the video data (e.g., 120a) or the audio data and the second group obtained by packetized the data 111a associated with the control image may have different communication priorities. For example, the second group of packets may have higher priority than that of the first group of packets. The electronic device 101 may preferentially transmit the second group of packets to the electronic device 102 depending on communication environment. In this case, a packet for the control image may be preferentially transmitted and processed. In another example, the first group of packets may have a higher communication priority than that of the second group of packets. The electronic device 101 may preferentially transmit the first group of packets to the electronic device 102 depending on communication environment. In this case, a packet for a background image may be preferentially transmitted and processed.

The data 111a associated with the control image may be displayed as a control button 121 on the display 120 of the second electronic device 102. Although it is exemplarily illustrated in FIG. 4 that the control button 121 is displayed at the lower end of an image 120a associated with the main content, embodiments are not limited thereto. In various embodiments, the data 111a associated with the control image may include information on an output position, output size, direction information, rotation information, and the like of the control button 121.

When a user input is generated in the control button 121, the second electronic device 102 may transmit a relevant signal to the first electronic device 101. The second electronic device 102 may establish a reverse channel, referred to as a user input back channel (UIBC), with the first electronic device 101. For example, each button included in the control button 121 may be mapped to a different code. When a user touches a back button, the second electronic device 102 may transmit a code corresponding to the back button to the first electronic device 101 via the UIBC. The first electronic device 101 may perform the same function (e.g., cancel execution, end app, previous screen, etc.) as in a case where a back button among hardware buttons 111 of the first electronic device 101 is touched.

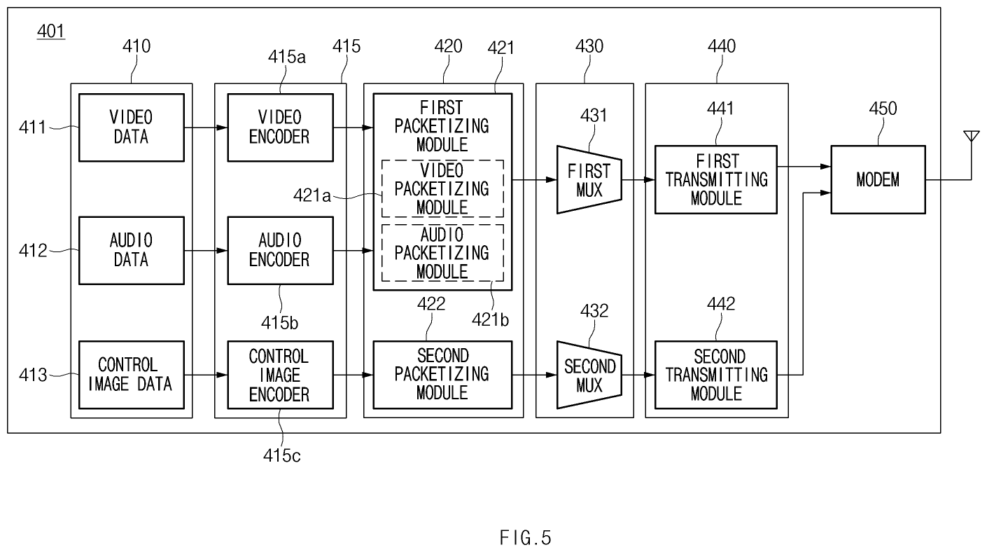

FIG. 5 is a block diagram of a source device according to various embodiments. Although a configuration for transmitting data according to the Miracast scheme is mainly illustrated in FIG. 5, embodiments are not limited thereto and some configurations may be omitted or added.

Referring to FIG. 5, a source device 401 may include a storage unit 410, an encoding unit 415, a packetizing unit 420, a multiplexing unit 430, a transmitting unit 440, and a modem 450. The components of the source device 401 may be implemented with various circuit elements, such as one or more microprocessors, a digital signal processor (DSP), an application specific integrated circuit (ASIC), a field programmable gate array (FPGA), discrete logic, software, hardware, firmware, and a combination of any two or more thereof.

The storage unit 410 may store video data 411, audio data 412, and control image data 413. For example, the storage unit 410 may include a random access memory (RAM) such as synchronous dynamic random access memory (SDRAM), a read-only memory (ROM), a non-volatile random access memory (NVRAM), a programmable read-only memory (EEPROM), a flash memory, and the like.

The storage unit 410 may store the entire media data file or may include a frame buffer that stores a part of the media data file to be streamed. For example, when the storage unit 410 stores the entire media data file, the video data 411 and the audio data 412 may be media files stored in a file format. When the storage unit 410 is the frame buffer that stores a part of the media data file to be streamed, the video data 411 and the audio data 412 may be image or sound data in frame units output through a display (not illustrated) of the source device 401.

The control image data 413 may store various types of control buttons to be displayed on a display of the sink device. According to various embodiments, data for the control image data 413 may be packetized independently of the video data 411 and the audio data 412.

The encoding unit 415 may obtain video data and audio data from the storage unit 410, and encode the video data, the audio data, and control image data in a specified format.

A video encoder 415a may encode video according to any number of video compression standards such as ITU-T H.261, ISO/IEC MPEG-1 Visual, ITU-T H.262 or ISO/IEC MPEG-2 Visual, ITU-T H.263, ISO/IEC MPEG-4 Visual, ITU-T H.264 (also known as ISO/IEC MPEG-4 AVC), VP8, and High Efficiency Video Coding (HEVC). In various embodiments, the video encoder 415a may compress the video data 411 using lossless or lossy compression techniques.

An audio encoder 415b may obtain the audio data 412 from the storage unit 410 and encode the audio data 412 in a specified format. The audio data 412 may be coded using multi-channel formats such as Digital (AC-3) or DTS (Digital Theater System). The audio data 412 may be coded using a compressed or uncompressed format. Examples of the compressed audio format may include MPEG-1, two audio layers II and III, AC-3, AAC, and examples of the uncompressed audio format may include a pulse-code modulated (PCM) audio format.

A control image encoder 415c may obtain the control image data 413 from the storage unit 410 and encode the control image data 413 in a specified format.

The packetizing unit 420 may include a first packetizing module 421 that packetizes the video data 411 and the audio data 412 and a second packetizing module 422 that packetizes the control image data 413.

The first packetizing module 421 may packetize the encoded video data and audio data into a first group. For example, the first packetizing module 421 may packetize the encoded video data and audio data as defined according to MPEG-2 Part 1.

According to various embodiments, the first packetizing module 421 may include a video packetizing module 421a and an audio packetizing module 421b. The video packetizing module 421a may packetize the encoded video data and the audio packetizing module 421b may packetize the encoded audio data.

The second packetizing module 422 may packetize the control image data 413 into a second group. The second packetizing module 422 may operate independently of the first packetizing module 421 and the control image data 413 may be packetized separately from the video data and audio data included in the first group.

The multiplexing unit 430 may include a first combining unit 431 that processes the first group of packets and a second combining unit 432 that processes the second group of packets. The first combining unit 431 may apply multiplexing techniques to combine video payload data and audio payload data. For example, the first combining unit 431 may encapsulate the packetized video data and audio data into an MPEG2 transport stream defined according to MPEG-2 Part 1. In various embodiments, the first combining unit 431 may provide error correction techniques as well as synchronization techniques for audio and video packets.

The second combining unit 432 may process the second group of packets. For example, the second combining unit 432 may encapsulate the packetized control image data into an MPEG2 transport stream defined according to MPEG-2 Part 1.

The transmitting unit 440 may include a first transmitting module 441 that processes the first group of packets and a second transmitting module 442 that processes the second group of packets.

The first transmitting module 441 may process media data for transmission to the sink device. In various embodiments, the first transmitting module 441 may be configured to perform communication using one of IP, TCP, UDP, RTP, and RSTP.

The second transmitting module 442 may process the control image data for transmission to the sink device. In various embodiments, the second transmitting module 442 may be configured to perform communication using UDP.

According to various embodiments, an encryption module (not illustrated) may be included between the transmitting unit 440 and the modem 450. The encryption module may write a special digital mark in the transport packet to protect the copyright of the image. For example, a data encryption module may be High-bandwidth Digital Content Protection (HDCP).

The modem 450 may perform physical and MAC layer processing. For example, the modem 450 may perform physical layer and MAC layer processing on the physical and MAC layers defined by the Wi-Fi standard (e.g., IEEE 802.11x), as provided by WFD. In other examples, the modem 450 may be configured to perform physical layer and MAC layer processing on one of WirelessHD, WiMedia, Wireless Home Digital Interface (WHDI), WiGig, and Wireless USB.

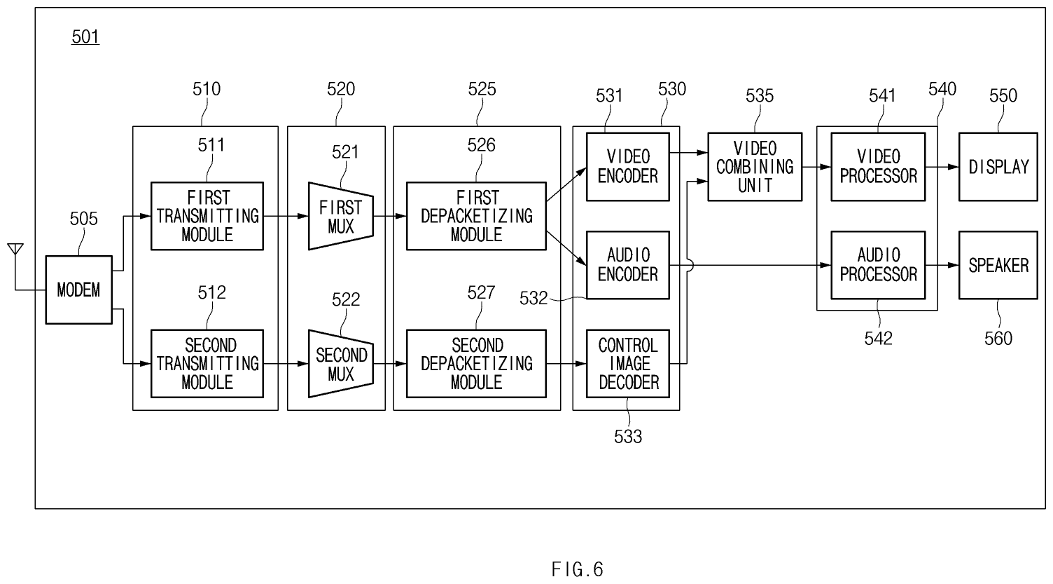

FIG. 6 is a block diagram of a sink device according to various embodiments. Although a configuration for receiving data according to the Miracast scheme is mainly illustrated in FIG. 6, embodiments are not limited thereto, and some configurations may be omitted or added.

Referring to FIG. 6, a sink device 501 includes a modem 505, a transmitting unit 510, a demultiplexing unit 520, a depacketizing unit 525, a decoding unit 530, a processor 540, a display 550, and a speaker 560. Each of the components of the sink device 501 may be implemented with various circuit elements, such as one or more microprocessors, a digital signal processor (DSP), an application specific integrated circuit (ASIC), a field programmable gate array (FPGA), discrete logic, software, hardware, firmware, and a combination of any two or more thereof.

The modem 505 may perform physical and MAC layer processing. For example, the modem 505 may be configured to perform physical layer and MAC layer processing on the physical and MAC layers defined by the Wi-Fi standard (e.g., IEEE 802.11x), as provided by WFD. In other examples, the modem 450 may be configured to perform physical layer and MAC layer processing on one of WirelessHD, WiMedia, Wireless Home Digital Interface (WHDI), WiGig, and Wireless USB.

The transmitting unit 510 may include a first transmitting module 511 that processes media data received from the source device 401 and a second transmitting module 512 that processes data for the control image.

The first transmitting module 511 may process feedback packets for transmission to the source device 401. For example, the first transmitting module 511 may be configured to perform communication using IP, TCP, UDP, RTP, and RSTP.

The second transmitting module 512 may process the second group of packets. For example, the first transmitting module 511 may be configured to perform communication using UDP.

The demultiplexing unit 520 may include a first demultiplexer 521 that processes a first group of packets and a second demultiplexer 522 that processes a second group of packets.

The first demultiplexer 521 may apply de-multiplexing techniques to separate video payload data and audio payload data from the data stream. In one embodiment, the first demultiplexer 521 may separate the packetized video and audio streams of MPEG2 transport streams defined according to MPEG-2 Part 1.

The second demultiplexer 522 may process the second group of packets including the control image data.

The depacketizing unit 525 and the decoding unit 530 may reversely perform operations performed in the packetizing unit 420 and the encoding unit 415 in FIG. 5 to extract video data, audio data, and control image data. In one embodiment, the depacketizing unit 525 may include a first depacketizing module 526 and a second depacketizing module 527. The decoding unit 530 may include a video decoder 531, an audio decoder 532, and a control image decoder 533.

According to various embodiments, a video combining unit 535 may combine the video data decoded by the video decoder 531 and the control image data decoded by the control image decoder 533. The video combining unit 535 may allow a part of the video data to be replaced with the control image data, or a part of the video data to be output by overlapping the control image data. The video combining unit 535 may provide the combined video data to a video processor 541.

The processor 540 may generate sound or an image based on the extracted video data, audio data, and control image data, and output it through the speaker 560 or the display 550.

The video processor 541 may receive the combined video data from the video combining unit 535. The video processor 541 may obtain captured video frames from the combined video data and process the video data for output on the display 550.

The display 550 may be various display devices such as a liquid crystal display (LCD), a plasma display, an organic light emitting diode (OLED) display, and the like.

An audio processor 542 may obtain the audio data from the audio decoder 532 and process the audio data for output to the speaker 560.

The speaker 560 may be various audio output devices, such as headphones, a single-speaker system, a multi-speaker system, or a surround sound system.

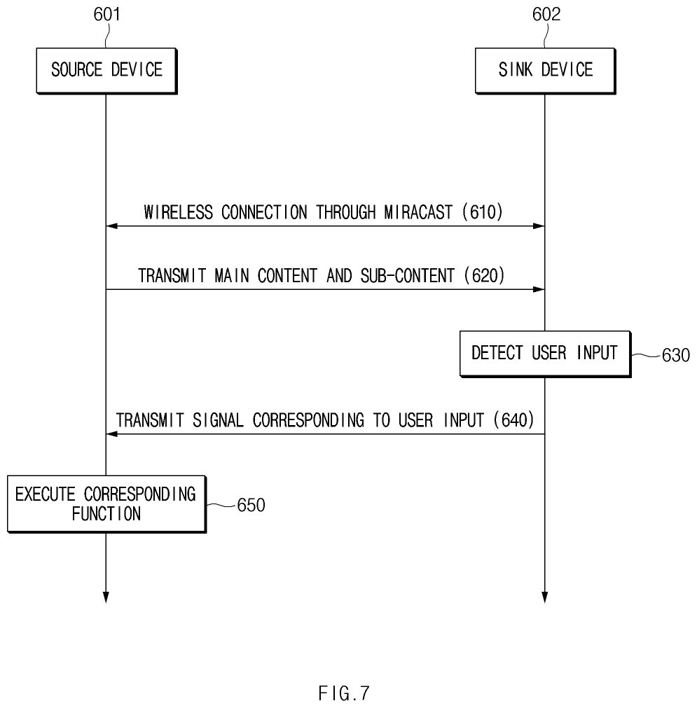

FIG. 7 is a diagram illustrating signal flow for transferring an input of a user in a sink device according to various embodiments.

Referring to FIG. 7, in operation 610, a source device 601 and a sink device 602 may wirelessly connect to each other according to the Miracast scheme.

In operation 620, the source device 601 may transmit main content and sub-content to the sink device 602. The source device 601 may packetize first data associated with the main content including video data or audio data into a first group and transmit the first data to the sink device 602. The source device 601 may packetize second data associated with the sub-content including control image data into a second group and transmit the second data to the sink device 602.

In operation 630, the sink device 602 may detect a user's input that is generated in a control image. For example, when the user touches a button included in the control image, the sink device 602 may identify a code mapped to the touched button.

In operation 640, the sink device 602 may transmit a signal corresponding to the button to the source device 601 via the UIBC. For example, the sink device 602 may transmit a code mapped to a button touched by the user to the source device 601.

According to various embodiments, the sink device 602 may transmit coordinate values in a coordinate system, which are obtained by performing negotiation on a touch signal with respect to a button touched by the user, to the source device 601 via the UIBC. The negotiation process may be a process of identifying a configuration or an output method between the devices before transmission of the video data according to the Miracast communication. The source device 601 may calculate a corresponding point in the coordinate system of the image (portrait mode or landscape mode) that is being transmitted to the sink device 602 with respect to the coordinate values received from the sink device 602, and perform a touch operation at the corresponding point.

For example, the source device 601 may be a smartphone operating in a portrait mode, and the sink device 602 may be a TV device output in a landscape mode. The source device 601 and the sink device 602 may wirelessly connect to each other according to a Miracast scheme and perform a screen mirroring operation. When the user's touch input (e.g., touch input) occurs in the sink device 602, the touched coordinates may be converted into negotiated coordinate values in a coordinate system and transmitted to the source device 601. The source device 601 may convert the received coordinate values to corresponding coordinates in a virtual display in the landscape mode, not in the portrait mode which is the current output mode. The source device 601 may perform a touch operation at a corresponding point (e.g., when a back key is arranged at the corresponding point, the source device 601 may perform the same operation as in a case where the back key is touched).

In various embodiments, the sink device 602 may transmit a signal corresponding to the user input to the source device 601, using the same communication protocol as a communication protocol via which the control image data was transmitted.

In operation 650, the source device 601 may perform a specified function based on a signal corresponding to the user input. For example, when the user executes the back button of the control image, functions such as undo, app exit, or previous screen may be executed.

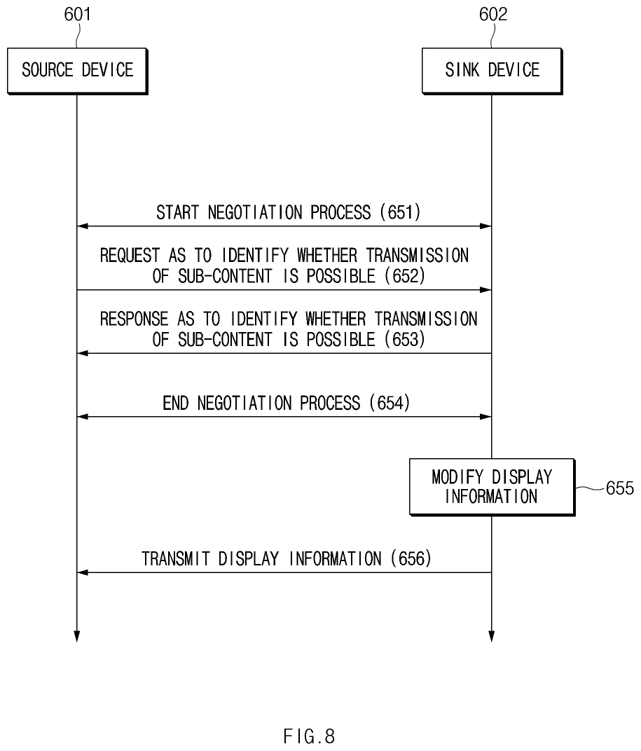

FIG. 8 is a diagram of signal flow illustrating a negotiation process in Miracast communication according to various embodiments.

Referring to FIG. 8, in operation 651, the source device 601 and the sink device 602 may initiate the negotiation process in the Miracast communication. The negotiation process may be a process of identifying the configuration or output method between the devices before transmission of the video data according to the Miracast communication.

In operation 652, the source device 601 may transmit, to the sink device 602, a request signal (e.g., an RSTP message) to identify whether transmission of sub-content by a second communication protocol is possible.

In operation 653, in response to the request signal, the sink device 602 may transmits a response signal (e.g., an RSTP message) to the source device 601 when it is possible to receive the sub-content by the second communication protocol. In various embodiments, the response signal (e.g., an RSTP message) may include information on the display information (e.g., resolution, display size, display rate, display direction, etc.) of the sink device 602.

According to various embodiments, the source device 601 may set video data or control image data to be transmitted through the Miracast communication, using the display information of the sink device 602.

For example, in a state where the source device 601 (e.g., a smartphone) is in the portrait mode and the sink device 602 (e.g., a TV) is in the landscape mode, the source device 601 may determine a transmission range and transmission size of the video data based on display direction information or resolution information included in the display information provided by the sink device 602. In addition, the source device 601 may generate a control image (or a user interface) suitable for the landscape mode through the virtual display.

In another example, when the source device 601 (e.g., a smart phone) is in the portrait mode and the sink device 602 (e.g., a TV) is in the landscape mode, the source device 601 may transmit the video data to the sink device 602 by a direct stream scheme. In this case, the source device 601 may transmit the video data to the sink device 602 as a direct stream, generate a separate user interface in the landscape mode suitable for the sink device 602 through the virtual display, and transmit the user interface to the sink device 602.

In operation 654, the source device 601 and the sink device 602 may end the negotiation process.

According to various embodiments, in operations 655 and 656, the sink device 602 may identify whether the display information is changed and transmit the changed display information to the source device 601. For example, when the display direction of the sink device 602 is changed from the portrait mode to the landscape mode, the sink device 602 may transmit an RTSP message including information on the landscape mode to the source device 601.

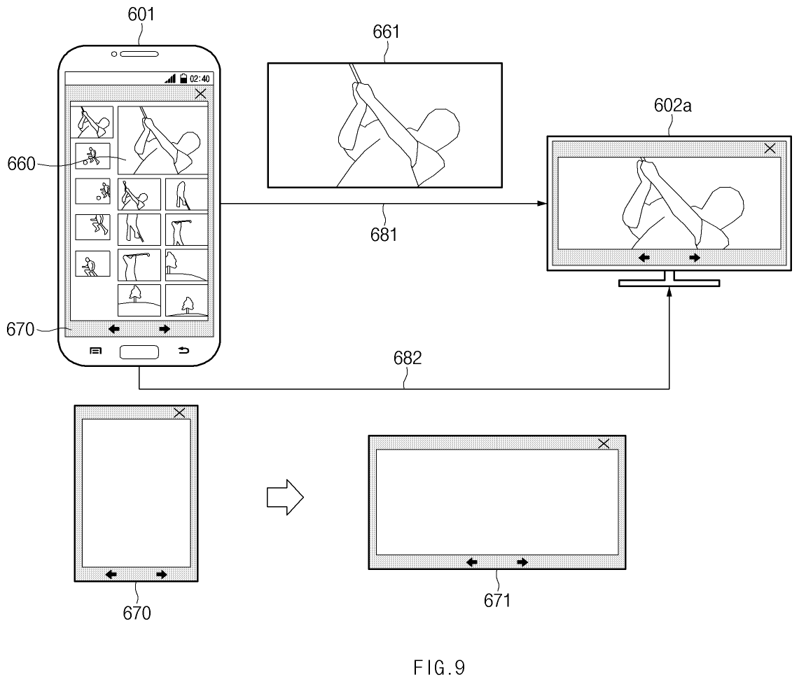

FIG. 9 is a first exemplary diagram for describing transmission of video images and control images according to types of a sink device according to various embodiments.

Referring to FIG. 9, the source device 601 may wirelessly connect to a sink device 602a according to the Miracast scheme. A video image 660 and a control image 670 may be being output to the display of the source device 601.

The source device 601 may transmit the video image 660 over a first channel 681 using a first communication protocol and transmit the control image 670 over a second channel 682 using a second communication protocol. For example, the first communication protocol may be a TCP and the second communication protocol may be a UDP.

The source device 601 may transmit a video image 661 for transmission, which is generated by modifying all or a part of the video image 660, over the first channel 681. The first channel 681 may be a channel using the video encoder 415a, the first packetizing module 421, the first combining unit 431, and the first transmitting module 441 in FIG. 5. The source device 601 may generate the video image 661 for transmission by reflecting the display information (e.g., display direction (e.g., landscape) or resolution) of the sink device 602a. In various embodiments, the display information of sink device 602a may be exchanged during the negotiation process in FIG. 7.

The source device 601 may transmit a control image 671 for transmission, into which the control image 670 is modified, over the second channel 682. The second channel 682 may be a channel using the control image encoder 415c, the second packetizing module 422, the second combining unit 432, and the second transmitting module 442 in FIG. 5. The source device 601 may generate the control image 671 for transmission by reflecting the display information (e.g., display direction (e.g., landscape) or resolution) of the sink device 602a. For example, the control image 671 for transmission may be an image in which the output size, the button position, and the like are changed in the control image 670.

The sink device 602a may receive the video image 661 for transmission and the control image 671 for transmission, respectively. The sink device 602a may output a screen based on the video image 661 for transmission and the control image 671 for transmission.

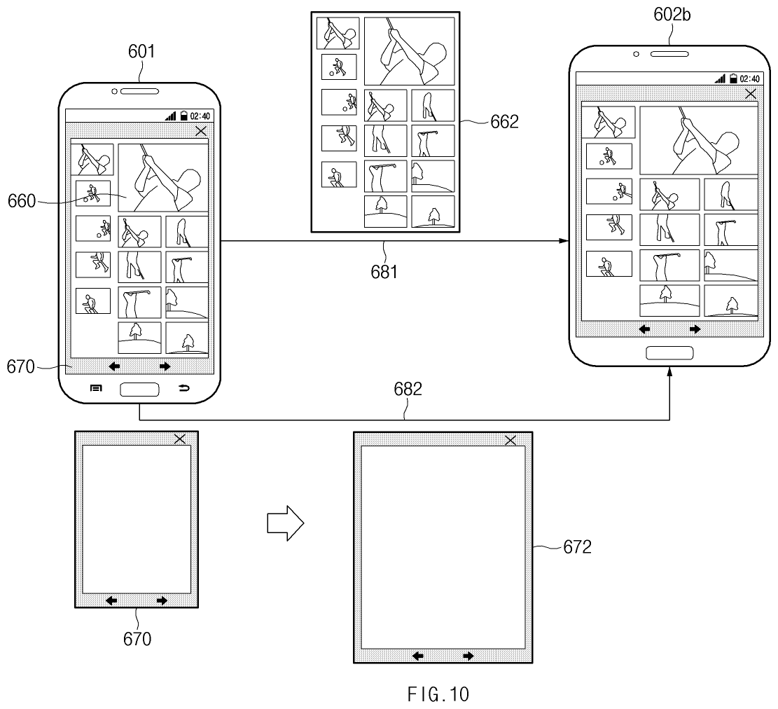

FIG. 10 is a second exemplary diagram for describing transmission of video images and control images according to types of a sink device according to various embodiments.

Referring to FIG. 10, the source device 601 may wirelessly connect to a sink device 602b according to the Miracast scheme. The video image 660 and the control image 670 may be being output to the display of the source device 601.

The source device 601 may transmit a video image 662 for transmission into which the video image 660 is modified, over the first channel 681. Unlike FIG. 9, the source device 601 and the sink device 602b may have the same display direction (e.g., portrait mode), but be different in the overall size, the vertical/horizontal ratio, etc. of the display. The source device 601 may generate the video image 662 for transmission by reflecting the display information (e.g., resolution or overall size, etc.) of the sink device 602.

The source device 601 may transmit a control image 672 for transmission into which the control image 670 is modified over the second channel 682. The source device 601 may generate the control image 672 for transmission by reflecting the display information of the sink device 602a (e.g., the overall size, the vertical/horizontal ratio of the display, etc.)

The sink device 602 may receive the video image 662 for transmission and the control image 672 for transmission respectively. The sink device 602 may output a screen based on the video image 662 for transmission and the control image 672 for transmission.

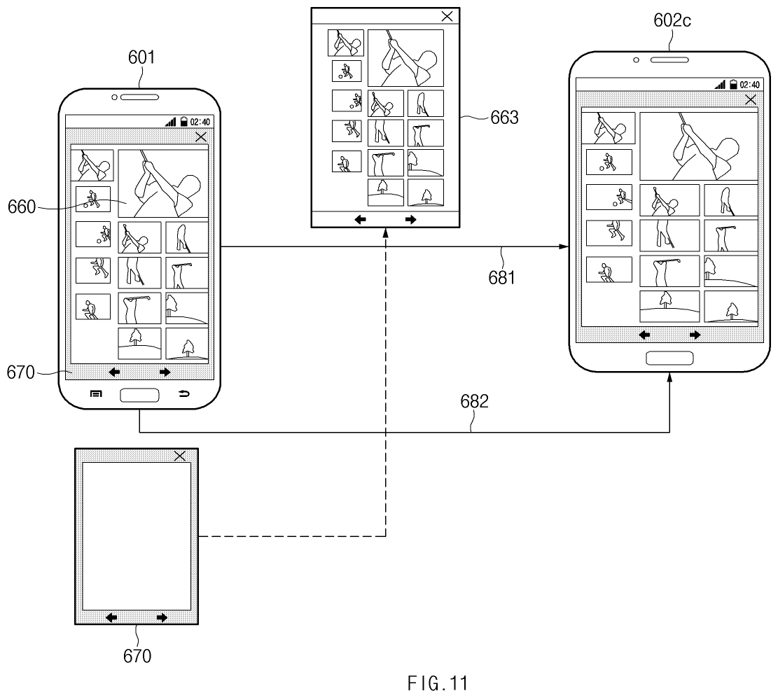

FIG. 11 is a third exemplary diagram for describing transmission of video images and control images according to types of a sink device according to various embodiments.

Referring to FIG. 11, the source device 601 may wirelessly connect to a sink device 602c according to the Miracast scheme. The video image 660 and the control image 670 may be being output to the display of the source device 601.

The source device 601 may transmit a video image 663 for transmission, into which the video image 660 is modified, through the first channel 681. Unlike FIG. 9 or 10, the source device 601 may generate the video image 663 for transmission by reflecting the control image 670. For example, the source device 601 may reflect display information (e.g., resolution or overall size, etc.) of the sink device 602 to the video image 660 and the control image 670, respectively. The source device 601 may combine the video image 660 and the control image 670, to which the display information of the sink device 602 has been reflected, into a single packet. The sink device 602 may output a screen based on the video image 663 for transmission.

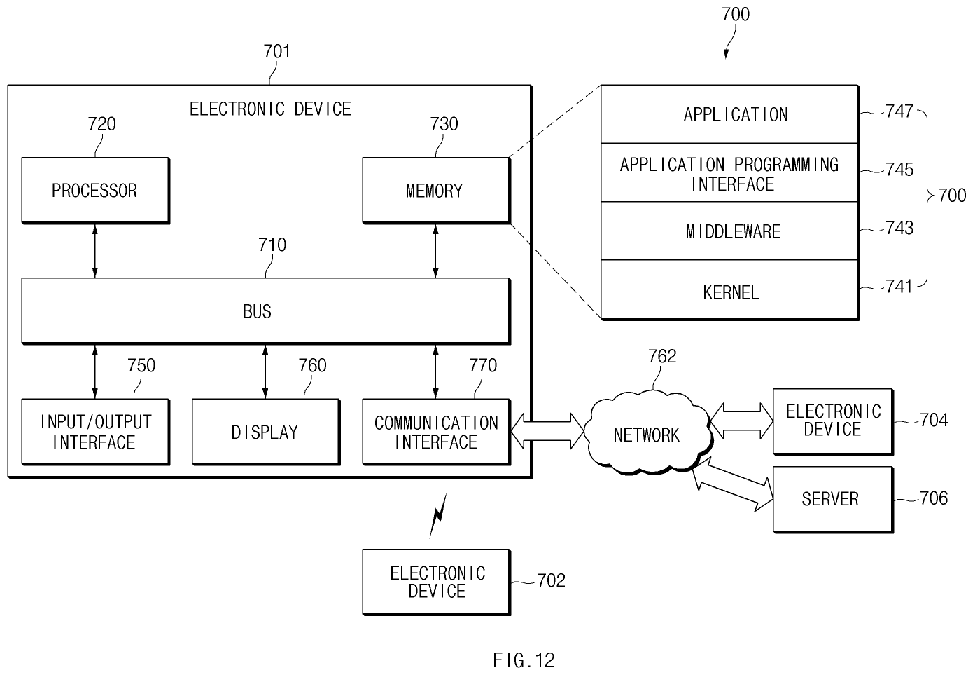

An electronic device 701 in a network environment 700 according to various embodiments of the present disclosure will be described with reference to FIG. 12. The electronic device 701 may include a bus 710, a processor 720, a memory 730, an input/output interface 750, a display 760, and a communication interface 770. In various embodiments of the present disclosure, at least one of the foregoing elements may be omitted or another element may be added to the electronic device 701. The bus 710 may include a circuit for connecting the above-mentioned elements 710 to 770 to each other and transferring communications (e.g., control messages and/or data) among the above-mentioned elements. The processor 720 may include at least one of a central processing unit (CPU), an application processor (AP), or a communication processor (CP). The processor 720 may perform data processing or an operation related to communication and/or control of at least one of the other elements of the electronic device 701.

The memory 730 may include a volatile memory and/or a nonvolatile memory. The memory 730 may store instructions or data related to at least one of the other elements of the electronic device 701. According to an embodiment of the present disclosure, the memory 730 may store software and/or a program 740. The program 740 may include, for example, a kernel 741, a middleware 743, an application programming interface (API) 745, and/or an application program (or an application) 747. At least a portion of the kernel 741, the middleware 743, or the API 745 may be referred to as an operating system (OS). The kernel 741 may control or manage system resources (e.g., the bus 710, the processor 720, the memory 730, or the like) used to perform operations or functions of other programs (e.g., the middleware 743, the API 745, or the application program 747). Furthermore, the kernel 741 may provide an interface for allowing the middleware 743, the API 745, or the application program 747 to access individual elements of the electronic device 701 in order to control or manage the system resources.

The middleware 743 may serve as an intermediary so that the API 745 or the application program 747 communicates and exchanges data with the kernel 741. Furthermore, the middleware 743 may handle one or more task requests received from the application program 747 according to a priority order. For example, the middleware 743 may assign at least one application program 747 a priority for using the system resources (e.g., the bus 710, the processor 720, the memory 730, or the like) of the electronic device 701. For example, the middleware 743 may handle the one or more task requests according to the priority assigned to the at least one application, thereby performing scheduling or load balancing with respect to the one or more task requests. The API 745, which is an interface for allowing the application 747 to control a function provided by the kernel 741 or the middleware 743, may include, for example, at least one interface or function (e.g., instructions) for file control, window control, image processing, character control, or the like. The input/output interface 750 may serve to transfer an instruction or data input from a user or another external device to (an)other element(s) of the electronic device 701. Furthermore, the input/output interface 750 may output instructions or data received from (an)other element(s) of the electronic device 701 to the user or another external device.

The display 760 may include, for example, a liquid crystal display (LCD), a light-emitting diode (LED) display, an organic light-emitting diode (OLED) display, a microelectromechanical systems (MEMS) display, or an electronic paper display. The display 760 may present various content (e.g., a text, an image, a video, an icon, a symbol, or the like) to the user. The display 760 may include a touch screen, and may receive a touch, gesture, proximity or hovering input from an electronic pen or a part of a body of the user. The communication interface 770 may set communications between the electronic device 701 and an external device (e.g., a first external electronic device 702, a second external electronic device 704, or a server 706). For example, the communication interface 770 may be connected to a network 762 via wireless communications or wired communications so as to communicate with the external device (e.g., the second external electronic device 704 or the server 706).

The wireless communications may employ at least one of cellular communication protocols such as long-term evolution (LTE), LIE-advance (LTE-A), code division multiple access (CDMA), wideband CDMA (WCDMA), universal mobile telecommunications system (UMTS), wireless broadband (WiBro), or global system for mobile communications (GSM). The wireless communications may include, for example, a short-range communications 764. The short-range communications may include at least one of wireless fidelity (Wi-Fi), Bluetooth, near field communication (NFC), magnetic stripe transmission (MST), or GNSS. The GNSS may include, for example, at least one of global positioning system (GPS), global navigation satellite system (GLONASS), BeiDou navigation satellite system (BeiDou), or Galileo, the European global satellite-based navigation system according to a use area or a bandwidth. Hereinafter, the term “GPS” and the term “GNSS” may be interchangeably used. The wired communications may include at least one of universal serial bus (USB), high definition multimedia interface (HDMI), recommended standard 832 (RS-232), plain old telephone service (POTS), or the like. The network 762 may include at least one of telecommunications networks, for example, a computer network (e.g., local area network (LAN) or wide area network (WAN)), the Internet, or a telephone network.

The types of the first external electronic device 702 and the second external electronic device 704 may be the same as or different from the type of the electronic device 701. According to an embodiment of the present disclosure, the server 706 may include a group of one or more servers. A portion or all of operations performed in the electronic device 701 may be performed in one or more other electronic devices (e.g., the first electronic device 702, the second external electronic device 704, or the server 706). When the electronic device 701 should perform a certain function or service automatically or in response to a request, the electronic device 701 may request at least a portion of functions related to the function or service from another device (e.g., the first electronic device 702, the second external electronic device 704, or the server 706) instead of or in addition to performing the function or service for itself. The other electronic device (e.g., the first electronic device 702, the second external electronic device 704, or the server 706) may perform the requested function or additional function, and may transfer a result of the performance to the electronic device 701. The electronic device 701 may use a received result itself or additionally process the received result to provide the requested function or service. To this end, for example, a cloud computing technology, a distributed computing technology, or a client-server computing technology may be used.

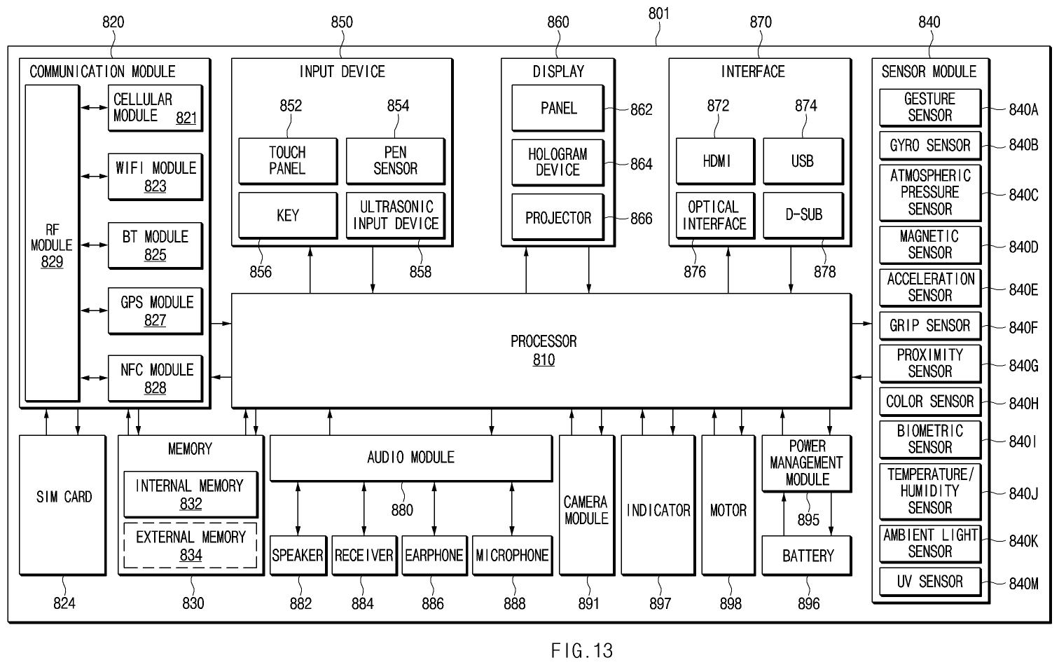

FIG. 13 is a block diagram illustrating an electronic device according to an embodiment of the present disclosure.

An electronic device 801 may include, for example, a part or the entirety of the electronic device 701 illustrated in FIG. 12. The electronic device 801 may include at least one processor (e.g., AP) 810, a communication module 820, a subscriber identification module (SIM) 824, a memory 830, a sensor module 840, an input device 850, a display 860, an interface 870, an audio module 880, a camera module 891, a power management module 895, a battery 896, an indicator 897, and a motor 898. The processor 810 may run an operating system or an application program so as to control a plurality of hardware or software elements connected to the processor 810, and may process various data and perform operations. The processor 810 may be implemented with, for example, a system on chip (SoC). According to an embodiment of the present disclosure, the processor 810 may further include a graphic processing unit (GPU) and/or an image signal processor. The processor 810 may include at least a portion (e.g., a cellular module 821) of the elements illustrated in FIG. 13. The processor 810 may load, on a volatile memory, an instruction or data received from at least one of other elements (e.g., a nonvolatile memory) to process the instruction or data, and may store various data in a nonvolatile memory.

The communication module 820 may have a configuration that is the same as or similar to that of the communication interface 770 of FIG. 12. The communication module 820 may include, for example, a cellular module 821, a Wi-Fi module 823, a Bluetooth (BT) module 825, a GNSS module 827 (e.g., a GPS module, a GLONASS module, a BeiDou module, or a Galileo module), a NFC module 828, and a radio frequency (RF) module 829. The cellular module 821 may provide, for example, a voice call service, a video call service, a text message service, or an Internet service through a communication network. The cellular module 821 may identify and authenticate the electronic device 801 in the communication network using the subscriber identification module 824 (e.g., a SIM card). The cellular module 821 may perform at least a part of functions that may be provided by the processor 810. The cellular module 821 may include a communication processor (CP). According to some various embodiments of the present disclosure, at least a part (e.g., two or more) of the cellular module 821, the Wi-Fi module 823, the Bluetooth module 825, the GNSS module 827, and the NFC module 828 may be included in a single integrated chip (IC) or IC package. The RF module 829 may transmit/receive, for example, communication signals (e.g., RF signals). The RF module 829 may include, for example, a transceiver, a power amp module (PAM), a frequency filter, a low noise amplifier (LNA), an antenna, or the like. According to another embodiment of the present disclosure, at least one of the cellular module 821, the Wi-Fi module 823, the Bluetooth module 825, the GNSS module 827, or the NFC module 828 may transmit/receive RF signals through a separate RF module. The SIM 824 may include, for example, an embedded SIM and/or a card containing the subscriber identity module, and may include unique identification information (e.g., an integrated circuit card identifier (ICCID)) or subscriber information (e.g., international mobile subscriber identity (IMSI)).

The memory 830 (e.g., the memory 730) may include, for example, an internal memory 832 or an external memory 834. The internal memory 832 may include at least one of a volatile memory (e.g., a dynamic RAM (DRAM), a static RAM (SRAM), a synchronous dynamic RAM (SDRAM), or the like), a nonvolatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, a NOR flash memory, or the like)), a hard drive, or a solid state drive (SSD). The external memory 834 may include a flash drive such as a compact flash (CF), a secure digital (SD), a Micro-SD, a Mini-SD, an extreme digital (xD), a MultiMediaCard (MMC), a memory stick, or the like. The external memory 834 may be operatively and/or physically connected to the electronic device 801 through various interfaces.

The sensor module 840 may, for example, measure physical quantity or detect an operation state of the electronic device 801 so as to convert measured or detected information into an electrical signal. The sensor module 840 may include, for example, at least one of a gesture sensor 840A, a gyro sensor 840B, a barometric pressure sensor 840C, a magnetic sensor 840D, an acceleration sensor 840E, a grip sensor 840F, a proximity sensor 840G, a color sensor 840H (e.g., a red/green/blue (RGB) sensor), a biometric sensor 840I, a temperature/humidity sensor 840J, an illumination sensor 840K, or an ultraviolet (UV) sensor 840M. Additionally or alternatively, the sensor module 840 may include, for example, an olfactory sensor (E-nose sensor), an electromyography (EMG) sensor, an electroencephalogram (EEG) sensor, an electrocardiogram (ECG) sensor, an infrared (IR) sensor, an iris recognition sensor, and/or a fingerprint sensor. The sensor module 840 may further include a control circuit for controlling at least one sensor included therein. In some various embodiments of the present disclosure, the electronic device 801 may further include a processor configured to control the sensor module 840 as a part of the processor 810 or separately, so that the sensor module 840 is controlled while the processor 810 is in a sleep state.

The input device 850 may include, for example, a touch panel 852, a (digital) pen sensor 854, a key 856, or an ultrasonic input device 858. The touch panel 852 may employ at least one of capacitive, resistive, infrared, and ultraviolet sensing methods. The touch panel 852 may further include a control circuit. The touch panel 852 may further include a tactile layer so as to provide a haptic feedback to a user. The (digital) pen sensor 854 may include, for example, a sheet for recognition which is a part of a touch panel or is separate. The key 856 may include, for example, a physical button, an optical button, or a keypad. The ultrasonic input device 858 may sense ultrasonic waves generated by an input tool through a microphone 888 so as to identify data corresponding to the ultrasonic waves sensed.

The display 860 (e.g., the display 760) may include a panel 862, a hologram device 864, or a projector 866. The panel 862 may have a configuration that is the same as or similar to that of the display 760 of FIG. 12. The panel 862 may be, for example, flexible, transparent, or wearable. The panel 862 and the touch panel 852 may be integrated into a single module. The hologram device 864 may display a stereoscopic image in a space using a light interference phenomenon. The projector 866 may project light onto a screen so as to display an image. The screen may be disposed in the inside or the outside of the electronic device 801. According to an embodiment of the present disclosure, the display 860 may further include a control circuit for controlling the panel 862, the hologram device 864, or the projector 866. The interface 870 may include, for example, an HDMI 872, a USB 874, an optical interface 876, or a D-subminiature (D-sub) 878. The interface 870, for example, may be included in the communication interface 770 illustrated in FIG. 12. Additionally or alternatively, the interface 870 may include, for example, a mobile high-definition link (MHL) interface, an SD card/multi-media card (MMC) interface, or an infrared data association (IrDA) interface.

The audio module 880 may convert, for example, a sound into an electrical signal or vice versa. At least a portion of elements of the audio module 880 may be included in the input/output interface 750 illustrated in FIG. 12. The audio module 880 may process sound information input or output through a speaker 882, a receiver 884, an earphone 886, or the microphone 888. The camera module 891 is, for example, a device for shooting a still image or a video. According to an embodiment of the present disclosure, the camera module 891 may include at least one image sensor (e.g., a front sensor or a rear sensor), a lens, an image signal processor (ISP), or a flash (e.g., an LED or a xenon lamp). The power management module 895 may manage power of the electronic device 801. According to an embodiment of the present disclosure, the power management module 895 may include a power management integrated circuit (PMIC), a charger integrated circuit (IC), or a battery or gauge. The PMIC may employ a wired and/or wireless charging method. The wireless charging method may include, for example, a magnetic resonance method, a magnetic induction method, an electromagnetic method, or the like. An additional circuit for wireless charging, such as a coil loop, a resonant circuit, a rectifier, or the like, may be further included. The battery gauge may measure, for example, a remaining capacity of the battery 896 and a voltage, current or temperature thereof while the battery is charged. The battery 896 may include, for example, a rechargeable battery and/or a solar battery.

The indicator 897 may display a specific state of the electronic device 801 or a part thereof (e.g., the processor 810), such as a booting state, a message state, a charging state, or the like. The motor 898 may convert an electrical signal into a mechanical vibration, and may generate a vibration or haptic effect. Although not illustrated, a processing device (e.g., a GPU) for supporting a mobile TV may be included in the electronic device 801. The processing device for supporting a mobile TV may process media data according to the standards of digital multimedia broadcasting (DMB), digital video broadcasting (DVB), MediaFLO™, or the like. Each of the elements described herein may be configured with one or more components, and the names of the elements may be changed according to the type of an electronic device. In various embodiments of the present disclosure, an electronic device may include at least one of the elements described herein, and some elements may be omitted or other additional elements may be added. Furthermore, some of the elements of the electronic device may be combined with each other so as to form one entity, so that the functions of the elements may be performed in the same manner as before the combination.

According to various embodiments, an electronic device includes a display, a memory, a communication module configured to transmit and receive data to and from an external electronic device and a processor configured to be electrically connected to the memory, the display, and the communication module, wherein the processor is configured to establish a channel with the external electronic device according to a Miracast scheme through the communication module, packetize first data including video data or audio data into a first group, packetize second data including control image data, which is output to receive a user input in the external electronic device, into a second group separately from the first group, transmit the first group of packets to the external electronic device according to a first communication protocol, and transmit the second group of packets to the external electronic device according to a second communication protocol.

According to an embodiment, the video data or the audio data is a portion of media data stored in a graphic RAM included within a display driver integrated circuit which drives the display. According to another embodiment, the video data or the audio data is a portion of media data stored in a file format in the memory.

According to various embodiments, the control image data includes information on a position, a size, and a type of a control image output on a display of the external electronic device.

According to various embodiments, the control image data includes a timing signal related to the first data. The first communication protocol is a communication protocol which is different from the second communication protocol. The first communication protocol is a Transmission Control Protocol (TCP), and the second communication protocol is a User Datagram Protocol (UDP). The first communication protocol is a bi-directional communication scheme between the electronic device and the external electronic device, and the second communication protocol is a uni-directional communication scheme according to which data is transmitted from the electronic device to the external electronic device.

According to various embodiments, the processor respectively packetizes the first data and the second data into a packetized elementary stream (PES) according to the Moving Picture Experts Group 2 (MPEG 2).

According to various embodiments, the processor connects to the external electronic device through the communication module according to a Wi-Fi Direct method.

According to various embodiments, the processor receives display information from the external electronic device, and modifies the video data or the control image data based on the display information. The display information includes at least one of resolution information, direction information, vertical/horizontal ratio information of a display mounted on the external electronic device.

The second electronic device according to various embodiments may perform wireless communication with the first electronic device and include a display, a sound output module that outputs sound, a memory, a communication module that transmits and receives data to and from an external electronic device, and a processor electrically connected to the memory, the display, and the communication module, wherein the processor may establish a channel with the first electronic device according to the Miracast scheme through the communication module, receive a first group of packets including video data or audio data and a second group of packets including control image data, extract the video data or the audio data from the first group of packets, extract the control image data from the second group of packets, combine the video data with the control image data to output the combined data through the display, and output the audio data through the sound output module.

According to various embodiments, the processor may receive the first group of packets from the first electronic device according to a first communication protocol and receive the second group of packets from the first electronic device according to a second communication protocol

According to various embodiments, when a user input is received in a control image output based on the control image data, the processor may transmit a signal corresponding to the second communication protocol to the first electronic device.

According to an embodiment, the processor may continuously output the control image output based on the control image data while the main content is output through the display. According to another embodiment, the processor may restrict the control image output based on the control image data from being output to the display according to a specified event.

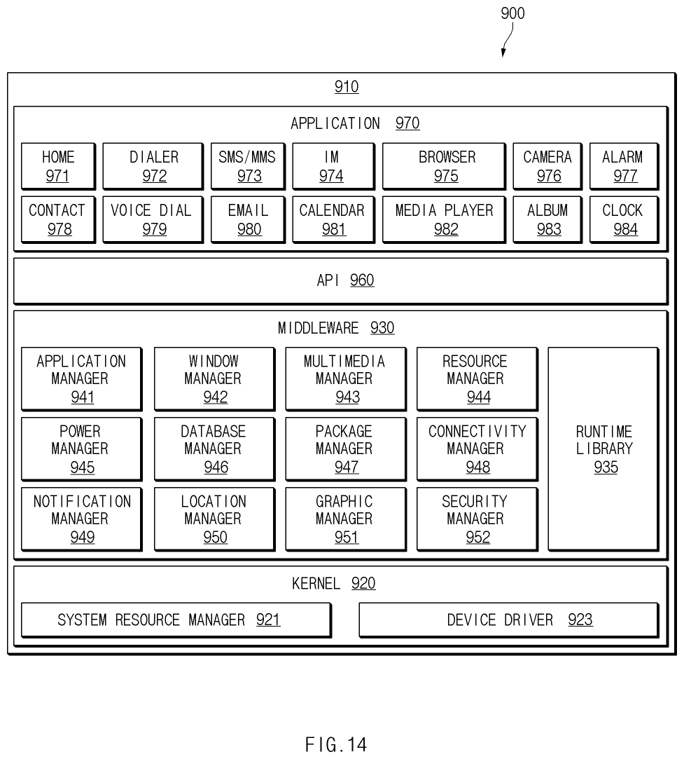

FIG. 14 is a block diagram illustrating a program module according to an embodiment of the present disclosure. According to an embodiment, a program module 910 (e.g., the program 740) may include an operating system (OS) for controlling a resource related to an electronic device (e.g., the electronic device 701) and/or various applications (e.g., the application program 747) running on the OS. The operating system may be, for example, Android, iOS, Windows, Symbian, Tizen, or the like. Referring to FIG. 14, the program module 910 may include a kernel 920, a middleware 930, an API 960, and/or an application 970. At least a part of the program module 910 may be preloaded on an electronic device or may be downloaded from an external electronic device (e.g., the first electronic device 702, the second external electronic device 704, or the server 706).

The kernel 920 (e.g., the kernel 741) may include, for example, a system resource manager 921 or a device driver 923. The system resource manager 921 may perform control, allocation, or retrieval of a system resource. According to an embodiment of the present disclosure, the system resource manager 921 may include a process management unit, a memory management unit, a file system management unit, or the like. The device driver 923 may include, for example, a display driver, a camera driver, a Bluetooth driver, a shared memory driver, a USB driver, a keypad driver, a Wi-Fi driver, an audio driver, or an inter-process communication (IPC) driver. The middleware 930, for example, may provide a function that the applications 970 require in common, or may provide various functions to the applications 970 through the API 960 so that the applications 970 may efficiently use limited system resources in the electronic device. According to an embodiment of the present disclosure, the middleware 930 (e.g., the middleware 743) may include at least one of a runtime library 935, an application manager 941, a window manager 942, a multimedia manager 943, a resource manager 944, a power manager 945, a database manager 946, a package manager 947, a connectivity manager 948, a notification manager 949, a location manager 950, a graphic manager 951, and a security manager 952.

The runtime library 935 may include, for example, a library module that a complier uses to add a new function through a programming language while the application 970 is running. The runtime library 935 may perform a function for input/output management, memory management, or an arithmetic function. The application manager 941 may mange, for example, a life cycle of at least one of the applications 970. The window manager 942 may manage a GUI resource used in a screen. The multimedia manager 943 may recognize a format required for playing various media files and may encode or decode a media file using a codec matched to the format. The resource manager 944 may manage a resource such as a source code, a memory, or a storage space of at least one of the applications 970. The power manager 945, for example, may operate together with a basic input/output system (BIOS) to manage a battery or power and may provide power information required for operating the electronic device. The database manager 946 may generate, search, or modify a database to be used in at least one of the applications 970. The package manager 947 may manage installation or update of an application distributed in a package file format.

The connectivity manger 948 may manage wireless connection of Wi-Fi, Bluetooth, or the like. The notification manager 949 may display or notify an event such as message arrival, appointments, and proximity alerts in such a manner as not to disturb a user. The location manager 950 may manage location information of the electronic device. The graphic manager 951 may manage a graphic effect to be provided to a user or a user interface related thereto. The security manager 952 may provide various security functions required for system security or user authentication. According to an embodiment of the present disclosure, in the case in which an electronic device (e.g., the electronic device 701) includes a phone function, the middleware 930 may further include a telephony manager for managing a voice or video call function of the electronic device. The middleware 930 may include a middleware module for forming a combination of various functions of the above-mentioned elements. The middleware 930 may provide a module specialized for each type of an operating system to provide differentiated functions. Furthermore, the middleware 930 may delete a part of existing elements or may add new elements dynamically. The API 960 (e.g., the API 745) which is, for example, a set of API programming functions may be provided in different configurations according to an operating system. For example, in the case of Android or iOS, one API set may be provided for each platform, and, in the case of Tizen, at least two API sets may be provided for each platform.

The application 970 (e.g., the application program 747), for example, may include at least one application capable of performing functions such as a home 971, a dialer 972, an SMS/MMS 973, an instant message (IM) 974, a browser 975, a camera 976, an alarm 977, a contact 978, a voice dial 979, an e-mail 980, a calendar 981, a media player 982, an album 983, a clock 984, health care (e.g., measure an exercise amount or blood sugar), or environmental information provision (e.g., provide air pressure, humidity, or temperature information). According to an embodiment of the present disclosure, the application 970 may include an information exchange application for supporting information exchange between the electronic device (e.g., the electronic device 701) and an external electronic device (e.g., the first electronic device 702 or the second external electronic device 704). The information exchange application may include, for example, a notification relay application for relaying specific information to the external electronic device or a device management application for managing the external electronic device. For example, the notification relay application may have a function for relaying, to an external electronic device (e.g., the first electronic device 702 or the second external electronic device 704), notification information generated in another application (e.g., an SMS/MMS application, an e-mail application, a health care application, an environmental information application, or the like) of the electronic device. Furthermore, the notification relay application may receive notification information from the external electronic device and may provide the received notification information to the user. The device management application, for example, may manage (e.g., install, delete, or update) at least one function (e.g., turn-on/turn off of the external electronic device itself (or some elements) or the brightness (or resolution) adjustment of a display) of the external electronic device (e.g., the first electronic device 702 or the second external electronic device 704) communicating with the electronic device, an application running in the external electronic device, or a service (e.g., a call service, a message service, or the like) provided from the external electronic device. According to an embodiment of the present disclosure, the application 970 may include a specified application (e.g., a healthcare application of a mobile medical device) according to an attribute of the external electronic device (e.g., the first electronic device 702 or the second external electronic device 704). The application 970 may include an application received from an external electronic device (e.g., the first electronic device 702 or the second external electronic device 704). The application 970 may include a preloaded application or a third-party application downloadable from a server. The names of the elements of the program module 910 illustrated may vary with the type of an operating system. According to various embodiments of the present disclosure, at least a part of the program module 910 may be implemented with software, firmware, hardware, or a combination thereof. At least a part of the program module 910, for example, may be implemented (e.g., executed) by a processor (e.g., the processor 810). At least a part of the program module 910 may include, for example, a module, a program, a routine, sets of instructions, or a process for performing at least one function.

The term “module” used herein may represent, for example, a unit including one of hardware, software and firmware or a combination thereof. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific integrated circuit (ASIC) chip, a field-programmable gate array (FPGA), and a programmable-logic device for performing some operations, which are known or will be developed. At least a part of devices (e.g., modules or functions thereof) or methods (e.g., operations) according to various embodiments of the present disclosure may be implemented as instructions stored in a computer-readable storage medium in the form of a program module. In the case where the instructions are performed by a processor (e.g., the processor 720), the processor may perform functions corresponding to the instructions. The computer-readable storage medium may be, for example, the memory 730. A computer-readable recording medium may include a hard disk, a floppy disk, a magnetic medium (e.g., a magnetic tape), an optical medium (e.g., CD-ROM, digital versatile disc (DVD)), a magneto-optical medium (e.g., a floptical disk), or a hardware device (e.g., a ROM, a RAM, a flash memory, or the like). The program instructions may include machine language codes generated by compilers and high-level language codes that can be executed by computers using interpreters. The above-mentioned hardware device may be configured to be operated as one or more software modules for performing operations of various embodiments of the present disclosure and vice versa. A module or a program module according to various embodiments of the present disclosure may include at least one of the above-mentioned elements, or some elements may be omitted or other additional elements may be added. Operations performed by the module, the program module or other elements according to various embodiments of the present disclosure may be performed in a sequential, parallel, iterative or heuristic way. Furthermore, some operations may be performed in another order or may be omitted, or other operations may be added.

1. An electronic device, comprising:
a display;
a memory;
a communication module configured to transmit and receive data to and from an external electronic device; and
a processor configured to be electrically connected to the memory, the display, and the communication module,
wherein the processor is configured to
establish a channel with the external electronic device according to a Miracast scheme through the communication module,
packetize first data including video data or audio data into a first group;
packetize second data including control image data, which is output to receive a user input in the external electronic device, into a second group separately from the first group,
transmit the first group of packets to the external electronic device according to a first communication protocol, and
transmit the second group of packets to the external electronic device according to a second communication protocol.

2. The electronic device of claim 1, wherein the video data or the audio data is a portion of media data stored in a graphic RAM included within a display driver integrated circuit which drives the display.

3. The electronic device of claim 1, wherein the video data or the audio data is a portion of media data stored in a file format in the memory.

4. The electronic device of claim 1, wherein the control image data includes information on a position, a size, and a type of a control image output on a display of the external electronic device.

5. The electronic device of claim 1, wherein the control image data includes a timing signal related to the first data.

6. The electronic device of claim 1, wherein the first communication protocol is a communication protocol which is different from the second communication protocol.

7. The electronic device of claim 1, wherein the first communication protocol is a Transmission Control Protocol (TCP), and
wherein the second communication protocol is a User Datagram Protocol (UDP).

8. The electronic device of claim 1, wherein the first communication protocol is a bi-directional communication scheme between the electronic device and the external electronic device, and
wherein the second communication protocol is a uni-directional communication scheme according to which data is transmitted from the electronic device to the external electronic device.

9. The electronic device of claim 1, wherein the processor respectively packetizes the first data and the second data into a packetized elementary stream (PES) according to the Moving Picture Experts Group 2 (MPEG 2).

10. The electronic device of claim 1, wherein the processor connects to the external electronic device through the communication module according to a Wi-Fi Direct method.

11. The electronic device of claim 1, wherein the processor receives display information from the external electronic device, and modifies the video data or the control image data based on the display information.

12. The electronic device of claim 10, wherein the display information includes at least one of resolution information, direction information, vertical/horizontal ratio information of a display mounted on the external electronic device.

13. A wireless communication method performed in an electronic device, comprising:
establishing a channel with an external electronic device according to a Miracast scheme;
packetizing first data including video data or audio data into a first group;
packetizing second data including control image data, which is output to receive a user input in the external electronic device, into a second group separately from the first group;
transmitting the first group of packets to the external electronic device according to a first communication protocol; and
transmitting the second group of packets to the external electronic device according to a second communication protocol.

14. The wireless communication method of claim 13, wherein the packetizing of the first data includes extracting media data stored in a graphic RAM included within a display driver integrated circuit which drives a display of the electronic device.

15. The wireless communication method of claim 13, wherein the packetizing of the first data includes extracting at least a part of a media file stored in a memory of the electronic device as video data or audio data.
